(19) United States
(12) Patent Application Publication
(10) Pub. No.: US 2014/0037963 A1
(43) Pub. Date: Feb. 6, 2014

(54) METHOD OF MANUFACTURING GRAPHENE FILM, APPARATUS FOR MANUFACTURING GRAPHENE FILM, AND GRAPHENE FILM MANUFACTURED BY USING APPARATUS FOR MANUFACTURING GRAPHENE FILM

(71) Applicant: Young-il Song, Changwon-city (KR)

(72) Inventor: Young-il Song, Changwon-city (KR)

(73) Assignee: SAMSUNG TECHWIN CO., LTD., Changwon-city (KR)

(21) Appl. No.: 14/009,152

(22) PCT Filed: Mar. 30, 2012
(86) PCT No.: PCT/KR12/02348

§ 371 Date: Oct. 9, 2013

(30) Foreign Application Priority Data
Apr. 1, 2011 (KR) 10-2011-0030284

(51) Int. Cl. C01B 31/04

(52) U.S. Cl. CPC C01B 31/0446; C01B 31/0484
USPC 428/408; 264/129; 427/314; 427/372.2; 118/75; 118/68

(57) ABSTRACT

A method of manufacturing a graphene film, the method including forming graphene on a surface of a catalyst metal film; forming a first film on a surface of the graphene, on which the catalyst metal film is not formed; removing the catalyst metal film; and performing a doping process on the graphene, wherein the forming of the graphene, the forming of the first film, the removing, and the performing are performed in one direction by using a roll-to-roll method.

### TECHNICAL FIELD

The present invention relates to a method of manufacturing a graphene film, an apparatus for manufacturing a graphene film, and a graphene film manufactured by using the apparatus.

### BACKGROUND ART

Graphene is a material obtained by connecting carbons with each other in a hexagonal form so as to constitute a honeycomb-formed two-dimensional planar structure, has a very small thickness, is transparent, and has great electric conductivity. Various attempts to apply graphene to a transparent display or a flexible display have been made using the above characteristics.

As an interest in graphene is increased, there is a need for a method of mass-producing graphene with high quality.

### DISCLOSURE OF INVENTION

### Technical Problem

The present invention provides a method of mass-producing a graphene film, an apparatus for manufacturing a graphene film, and a graphene film manufactured by using the method.

### Solution to Problem

According to an aspect of the present invention, there is provided a method of manufacturing a graphene film, the method including forming graphene on a surface of a catalyst metal film; forming a first film on a surface of the graphene, on which the catalyst metal film is not formed; removing the catalyst metal film; and performing a doping process on the graphene, wherein the forming of the graphene, the forming of the first film, the removing, and the performing are performed in one direction by using a roll-to-roll method.

The method may further include: prior to the forming of the graphene, preprocessing the catalyst metal film, wherein the catalyst metal film is moved to the forming of the graphene by using a roll-to-roll method.

The catalyst metal film may include at least one selected from the group consisting of nickel (Ni), cobalt (Co), iron (Fe), platinum (Pt), gold (Au), aluminum (Al), chromium (Cr), copper (Cu), magnesium (Mg), manganese (Mn), roseum (Rh), silicon (Si), tantalum (Ta), titanium (Ti), tungsten (W), uranium (U), vanadium (V), and zirconium (Zr), and a combination thereof.

The first film may include at least one of polyethylene terephthalate (PET), polyimide (PI), polydimethylsiloxane (PDMS), plastic, synthetic rubber, and natural rubber.

The method may further include forming an adhesive material between the first film and the graphene.

The method may further include: after the removing is performed, removing the first film and forming a second film on a surface of the graphene, on which the first film is not formed.

The first film may be a thermal peel film, and the second film may include at least one of polyethylene terephthalate (PET), polyimide (PI), polydimethylsiloxane (PDMS), plastic, synthetic rubber, and natural rubber.

The removing of the first film and the forming of the second film may be performed in one direction by using a roll-to-roll method.

The removing may be performed by using an etching process.

The etching process may be a wet etching process using at least one of an acid solution, a hydrogen fluoride (HF) solution, a buffered oxide etch (BOE) solution, a ferric chloride (FeCl3) solution, and a ferric nitrate (Fe(No3)3) solution.

The method may further include: prior to the wet etching process, dry-etching the catalyst metal film.

The method may further include: between the removing and the performing of the doping process, washing and drying the graphene, wherein the washing and drying are performed by using a roll-to-roll method.

The method may further include: after the performing of the doping process, drying the graphene on which the doping process is performed by using one dry method selected from an air blowing method, a natural drying method, and a heating method at a temperature of about 50° C., wherein the selected method is performed by using a roll-to-roll method.

According to another aspect of the present invention, there is provided an apparatus for manufacturing a graphene film, the apparatus including a graphene forming unit for forming graphene on a surface of a catalyst metal film; a first film forming unit for forming a first film on a surface of the graphene, on which the catalyst metal film is not formed; a catalyst metal film removing unit for removing the catalyst metal film; and a graphene doping unit for performing a doping process on the graphene, wherein the graphene forming unit, the first film forming unit, the catalyst metal film removing unit, and the graphene doping unit are connected by using a roll-to-roll method.

The apparatus may further include a preprocessor for preprocessing the catalyst metal film before graphene is formed on a surface of the catalyst metal film, wherein the pre-processor and the graphene forming unit are connected by using a roll-to-roll method.

The apparatus may further include a graphene drying unit for drying graphene on which the doping process is performed, wherein the graphing doping unit and the graphene drying unit are connected by using a roll-to-roll method.

According to another aspect of the present invention, there is provided an graphene film manufacturing the above-described method.

### Advantageous Effects of Invention

According to a method and apparatus for manufacturing a graphene film, a manufacturing method including a process of synthesizing graphene, an etching process, and a transfer process is performed by using a roll-to-roll method, thereby mass-producing a graphene film. In addition, dry etching is performed on a catalyst metal film prior to wet etching, thereby reducing a total period of time for an etching process.

### BRIEF DESCRIPTION OF DRAWINGS

The above and other features and advantages of the present invention will become more apparent by describing in detail exemplary embodiments thereof with reference to the attached drawings in which:

FIG. 1 is a flowchart of a method of manufacturing a graphene film, according to an embodiment of the present invention;

FIG. 2 schematically illustrates a method of manufacturing a graphene film, according to an embodiment of the present invention;

FIG. 3 is a side cross-sectional view of a portion III of the graphene film of FIG. 2, according to an embodiment of the present invention;

FIG. 4 is a side cross-sectional view of a portion IV of the graphene film of FIG. 2, according to an embodiment of the present invention;

FIG. 5 is a side cross-sectional view of a portion V of the graphene film of FIG. 2, according to an embodiment of the present invention;

FIG. 6 is a side cross-sectional view of a portion VI of the graphene film of FIG. 2, according to an embodiment of the present invention;

FIG. 7 is a side cross-sectional view of a portion VII of the graphene film of FIG. 2, according to an embodiment of the present invention;

FIG. 8 is a flowchart of a method of manufacturing a graphene film, according to another embodiment of the present invention:

FIG. 9 schematically illustrates a method of manufacturing a graphene film, according to another embodiment of the present invention;

FIG. 10 is a side cross-sectional view of a portion X of the graphene film of FIG. 9, according to another embodiment of the present invention;

FIG. 11 is a side cross-sectional view of a portion XI of the graphene film of FIG. 9, according to another embodiment of the present invention;

FIG. 12 is a side cross-sectional view of a portion XII of the graphene film of FIG. 9, according to another embodiment of the present invention; and

FIG. 13 is a side cross-sectional view of a portion XIII of the graphene film of FIG. 9, according to another embodiment of the present invention.

### MODE FOR THE INVENTION

Hereinafter, a method of manufacturing a film including graphene according to an exemplary embodiment will be described with reference to the accompanying drawings. Expressions such as “at least one of,” when preceding a list of elements, modify the entire list of elements and do not modify the individual elements of the list.

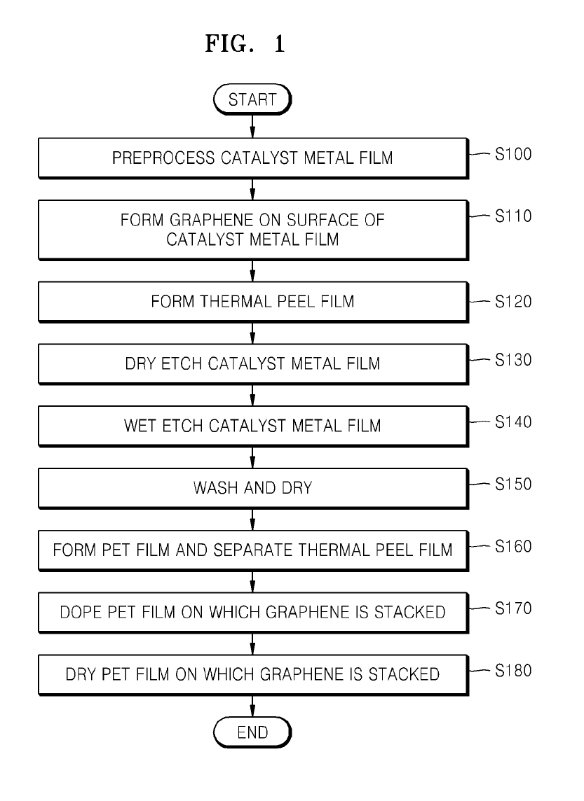

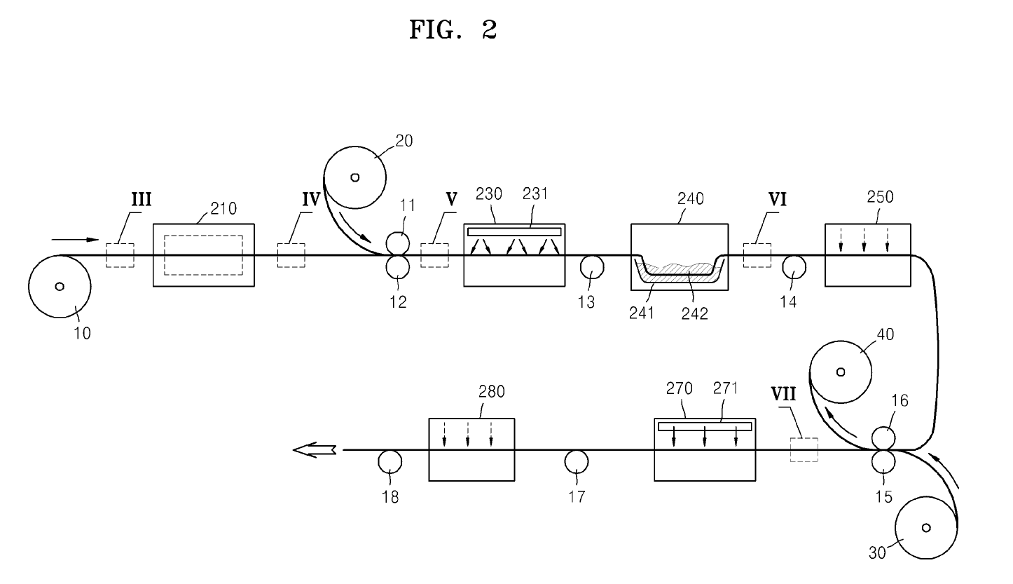

FIG. 1 is a flowchart of a method of manufacturing a graphene film, according to an embodiment of the present invention. FIG. 2 schematically illustrates a method of manufacturing a graphene film, according to an embodiment of the present invention. FIGS. 3 through 7 are side cross-sectional views of a graphene film formed through operations of FIG. 2, according to an embodiment of the present invention. Referring to FIGS. 1 through 7, the thicknesses of a catalyst metal film 301, graphene 302, a thermal peel film 303, and a polyethylene terephthalate (PET) film 304 are exaggerated for convenience of description.

First, a preprocess (S100) of a catalyst metal film is performed. Referring to FIG. 2, a catalyst metal film 301 (refer to FIG. 3) wound on a first winding roll 10 is moved to a graphene forming space 210 while being released from the first winding roll 10.

The catalyst metal film 301 may include at least one of selected from the group consisting of nickel (Ni), cobalt (Co), iron (Fe), platinum (Pt), gold (Au), aluminum (Al), chromium (Cr), copper (Cu), magnesium (Mg), manganese (Mn), roseum (Rh), silicon (Si), tantalum (Ta), titanium (Ti), tungsten (W), uranium (U), vanadium (V), and zirconium (Zr), and a combination thereof.

According to the present embodiment, the catalyst metal film 301 is a single layer. However, the present invention is not limited thereto. For example, one layer of a multilayered substrate including at least two layers may be the catalyst metal film 301. In this case, the catalyst metal film 301 is disposed. at the outermost layer of the multilayered substrate.

While the catalyst metal film 301 is moved in the graphene forming space 210, the preprocess (S100) of washing a surface of the catalyst metal film 301 may be performed. In the preprocess (S100), hydrogen gases may be used to remove impurities that exit on the surface of the catalyst metal film 301. Alternatively, the surface of the catalyst metal film 301 may be washed by using acid/alkali solutions so as to prevent defects that are caused during formation of the graphene 301, which is a subsequent process.

The preprocess (S100) of washing the surface of the catalyst metal film 301 may be omitted if necessary, or alternatively, may be performed before the catalyst metal film 301 is wound on the first winding roll 10.

Then, a graphene forming process (S110) is performed. Referring to FIG. 2, when the catalyst metal film 301 is moved to the graphene forming space 210, a gaseous carbon source is injected into the graphene forming space 210 and is thermally treated. The thermal treatment is performed by heating and cooling. The graphene forming process (S110) may be performed by using various processes such as chemical vapor deposition (CVD), thermal chemical vapor deposition (TCVD), rapid thermal chemical vapor deposition (PTCVD), inductive coupled plasma chemical vapor deposition (ICP-CVD), atomic layer deposition (ATLD), and the like.

The gaseous carbon source may be at least one selected from the group consisting of compounds including a carbon atom, such as methane (CH4), carbon monoxide (CO), ethane (C2H6), ethylene (CH2), ethanol (C2H5), acetylene (C2H2), propane (CH3CH2CH3), propylene (C3H6), butane (C4H10), pentane (CH3(CH2)3CH3), pentene (C5H10), cyclopentadiene (C5H6), hexane (C6H14), cyclohexane (C6H12), benzene (C6H6), toluene (C7H8), and the like. The gaseous carbon source is divided into carbon atoms and a hydrogen atom at a high temperature.

The divided carbon atom is vapor-deposited on the catalyst metal film 301 that is heated and is formed as the graphene 302 while the catalyst metal film 301 is cooled.

The catalyst metal film 301 on which the graphene 302 is formed is carried out of the graphene forming space 210 by using a moving roller (not shown). FIG. 4 is a side cross-sectional view of the graphene 302 formed on the catalyst metal film 301, according to an embodiment of the present invention.

The graphene forming space 210 may be a single device in which both heating and cooling are performed, or alternatively, may include a plurality of devices in which heating and cooling are respectively performed such that heating and cooling may be performed in respective spaces.

According to the present embodiment, the preprocess of washing the surface of the catalyst metal film 301 is performed before the catalyst metal film 301 is moved to the graphene forming space 210. However, the present invention is not limited to this order. For example, the preprocess may be performed by using hydrogen gas or the like before the gaseous carbon source is injected into the catalyst metal film 301 that is moved to the graphene forming space 210. In this case, the graphene forming space 210 may include a separate preprocess space.

Then, a thermal peel film is formed (S120). Referring to FIG. 2, the thermal peel film 303 wound on a second winding roll 20 is moved to a first attaching roller 11 while being released, and while the catalyst metal film 301, on which the graphene 302 moved from the graphene forming space 210 is formed, is moved to a second attaching roller 12, the thermal peel film 303 is formed on a surface of the graphene 302, on which the catalyst metal film 301 is not formed. The thermal peel film 303 has one surface having adhesive properties at room temperature and looses the adhesive properties when being heated at a predetermined peeling temperature or more. Thus, the thermal peel film 313 may be selected as a product having various peeling temperatures.

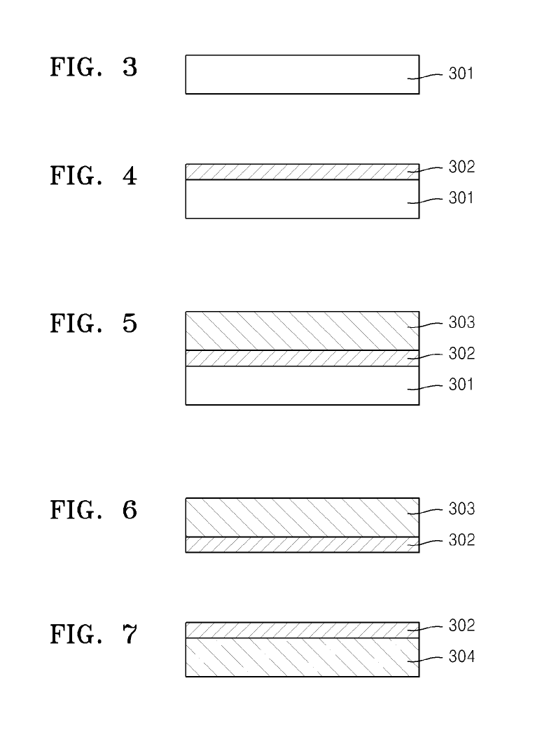

The first and second attaching rollers 11 and 12 are spaced apart from each other, a movement path of the catalyst metal film 301 is disposed between the first and second attaching rollers 11 and 12 and are attached to each other by pressurizing the thermal peel film 303 wound on the second winding roll 20 and the catalyst metal film 301 on which the graphene 302 moved from the graphene forming space 210 is formed. FIG. 5 is a side cross-sectional view of the thermal peel film 303 that is transferred to be formed on a surface of the graphene 302, on which the catalyst metal film 301 is not formed, according to an embodiment of the present invention.

According to the present embodiment, the thermal peel film 303 is used as a carrier film. However, the present invention is not limited thereto. Other various carrier films other than a thermal peel film may be used to move the graphene 302 to a transfer target film.

Then, a dry etching process (S130) is performed on the catalyst metal film 301. Referring to FIG. 2, the catalyst metal film 301, on which the graphene 302 attached to the thermal peel film 303 is formed, is moved to a moving roller (not shown) and is moved to a dry etching space 230 by using a roll-to-roll method. For example, in the dry etching process (S130), the surface of the catalyst metal film 301, on which the graphene 302 is not formed, may be plasma-etched or polished prior to a wet etching process that will be described, thereby reducing a total period of time for an etching process. If necessary, the dry etching process (S130) of the catalyst metal film 301 may be omitted.

Then, a wet etching process (S140) is performed on the catalyst metal film 301. Referring to FIG. 2, a graphene structure including the catalyst metal film 301 that is dry etched is moved to a wet etching space 240 by using a roll-to-roll method using a moving roller 13. Examples of an etching solution may include an acid solution, a hydrogen fluoride (HF) solution, a buffered oxide etch (BOE) solution, a ferric chloride (FeCl3) solution, and a ferric nitrate (Fe(No3)3) solution.

Referring to FIG. 6, the dry etching process (S130) and the wet etching process (S140) are performed to remove the catalyst metal film 301 from the graphene 302. In FIG. 6, the wet etching space 240 is configured such that an etching solution 242 is contained in a vessel 241. However, the present invention is not limited thereto. The wet etching space 240 may also be configured to have various devices including, for example, a sprayer for spraying etching solutions.

Then, a washing and drying process (S150) is performed. Referring to FIG. 2, the thermal peel film 303 formed on the graphene 302 that is completely wet-etched is moved to a washing and drying space 250 by using a moving roller 14. In the washing and drying space 250, an etching solution that remains on the thermal peel film 303 including the graphene 302 is removed.

Then, the thermal peel film 303 is separated and the PET film 304 is formed (S160). Referring to FIG. 2, the PET film 304 wound on a third winding roll 30 is moved to a third attaching roller 15 while being released. In addition, the thermal peel film 303 on which the graphene 302 carried out of the washing and drying space 250 is formed is moved to a fourth attaching roller 16. The graphene 302 on which the thermal peel film 303 is not formed is transferred on the PET film 304 and the thermal peel film 303 is separated from the graphene 302 and returns to a fourth winding roll 40, by using the third attaching roller 15 and the fourth attaching roller 16 that face each other.

FIG. 7 is a side cross-sectional view showing a case where the thermal peel film 303 is separated from the graphene 302 and the graphene 302 is coated on the PET film 304, according to an embodiment of the present invention. The PET film 304 on which the graphene 302 is coated may be used as a transparent film of a flexible display, an organic light-emitting device, a solar cell, or the like.

According to the present embodiment, the PET film 304 is used as a transfer target film on which graphene is transferred. However, the present invention is not limited thereto. A transfer target film on which graphene is transferred may include at least one of polyimide (PI), polydimethylsiloxane (PDMS), plastic, synthetic rubber, and natural rubber, in addition to the PET film 304.

Then, a graphene doping process (S170) is performed. Referring to FIG. 2, the PET film 304 including the graphene 302 formed thereon is moved to a moving roller (not shown) and is moved to a doping space 270 by using a roll-to-roll method. For example, in the graphene doping process (S170), wet or dry doping using acid may be performed on the graphene 302 formed on the PET film 304.

Then, a dry process (S180) is performed. Referring to FIG. 2, the PET film 304 on which the graphene 302, on which the graphene doping process (S170) is completely performed, is formed is moved to a moving roller 17 and is moved to a dry space 280 by using a roll-to-roll method. For example, the dry process (S180) may be performed by air blowing. However, the present invention is not limited thereto. If necessary, the dry process (S180) may be performed by using a natural drying method, instead of air blowing. Alternatively, in the dry process (S180), the PET film 304 including the graphene 302 that is completely doped may be dried by heating the PET film 304 at a temperature of about 50° C.

The PET film 304 including the graphene 302 on which the dry process (S180) is completely performed is moved to a moving roller 18 by using a roll-to-roll method and then an analysis process (not shown) may be further performed.

As described above, in the method of manufacturing a graphene film according to the embodiment, an entire process is performed by using a roll-to-roll method and thus a graphene film may be mass produced. In addition, a catalyst metal film is dry-etched before being wet-dried, thereby reducing a total period of time for etching.

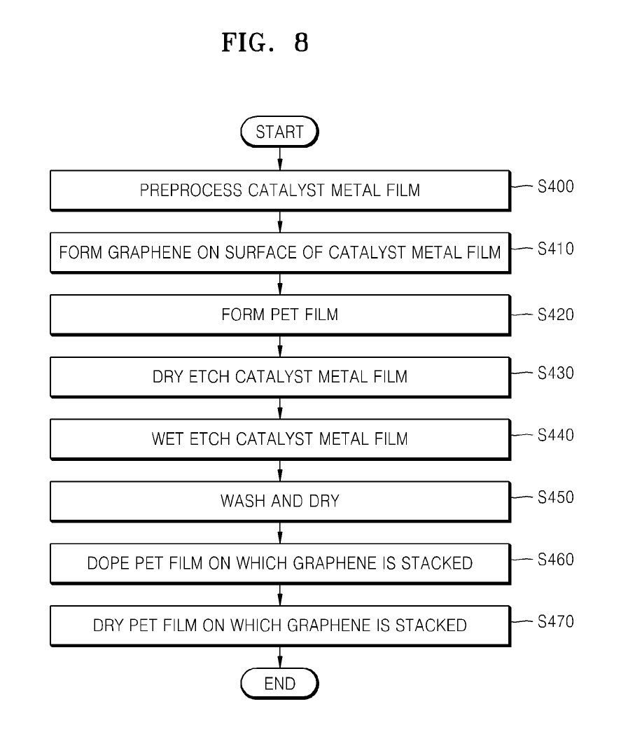

Hereinafter, a method of manufacturing a graphene film according to another embodiment of the present invention will be described with reference to FIGS. 8 through 13. Like reference numerals in the drawings denote like elements. Thus, the method will be described in terms of differences from the above-described embodiment.

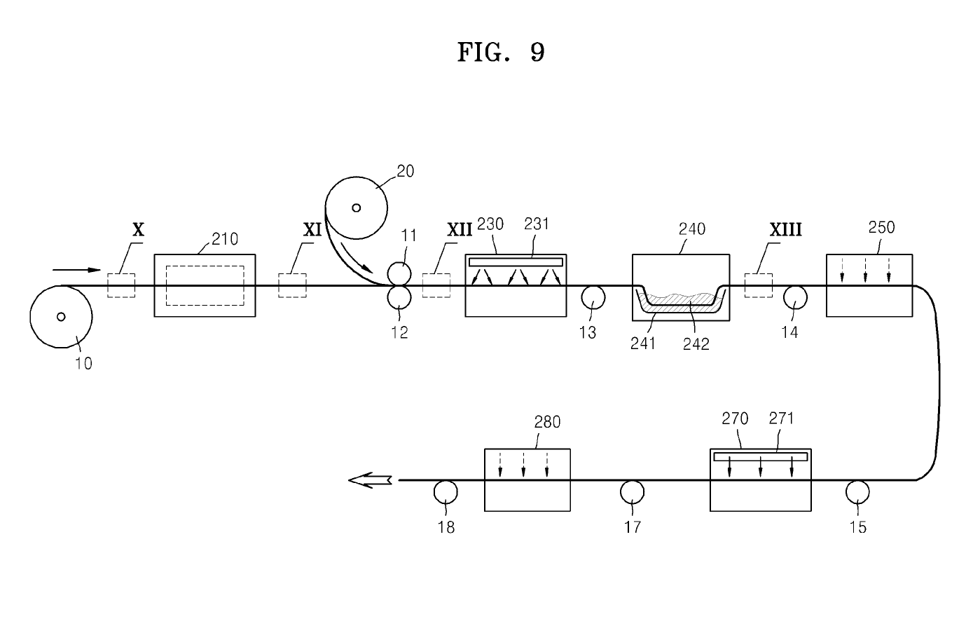

FIG. 8 is a flowchart of a method of manufacturing a graphene film, according to another embodiment of the present invention. FIG. 9 schematically illustrates a method of manufacturing a graphene film, according to another embodiment of the present invention. FIGS. 10 through 13 are side cross-sectional views of a graphene film formed through operations of FIG. 9, according to another embodiment of the present invention.

Like in the above-described embodiment, a preprocess (S400) of a catalyst metal film is performed. Referring to FIG. 9, the catalyst metal film 301 wound on the first winding roll 10 is moved to the graphene forming space 210 while being released from the first winding roll 10.

While the catalyst metal film 301 is moved to the graphene forming space 210, the preprocess (S400) of washing a surface of the catalyst metal film 301 may be performed. If necessary, the preprocess (S400) of washing the surface of the catalyst metal film 301 may be omitted or may be performed before the catalyst metal film 301 is wound on the first winding roll 10.

Then, like in the above-described embodiment, a graphene forming process (S410) is performed. Referring to FIG. 9, when the catalyst metal film 301 is moved to the graphene forming space 210, a gaseous carbon source is injected into the graphene forming space 210 and is thermally treated. The thermal treatment is performed by heating and cooling. The divided carbon atom is vapor-deposited on the catalyst metal film 301 that is heated and is formed as the graphene 302 while the catalyst metal film 301 is cooled.

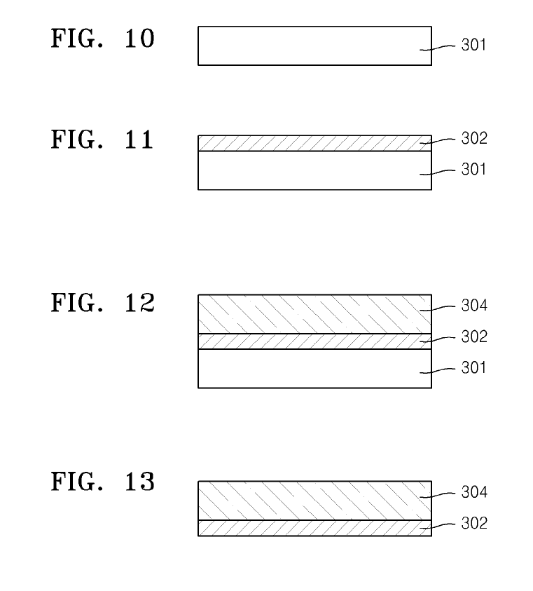

The catalyst metal film 301 on which the graphene 302 is formed is carried out of the graphene forming space 210 by using a moving roller (not shown). FIG. 11 is a side cross-sectional view of the graphene 302 formed on the catalyst metal film 301, according to another embodiment of the present invention.

Then, unlike in the above-described embodiment, the PET film 304 is formed directly on the graphene 302 (S420). Referring to FIG. 9, the PET film 304 wound on the second winding roil 20 is moved to the first attaching roller 11 while being released from the second winding roll 20, and while the catalyst metal film 301, on which the graphene 302 moved from the graphene forming space 210 is formed, is moved to the second attaching roller 12, the PET film 304 is formed directly on a surface of the graphene 302, on which the catalyst metal film 301 is not formed, as shown in FIG. 12.

In the above-described embodiment, the graphene 302 is first transferred on the thermal peel film 303 that is a carrier, the catalyst metal film 301 is removed from the graphene 302, and then the graphene 302 is finally transferred on the PET film 304 that is a transfer target film. However, according to the present embodiment, the PET film 304 is formed directly on the graphene 302 without an intermediary process such as processes for forming and separating the thermal peel film 303. Thus, a total period of time for manufacturing a graphene film may be reduced.

The PET film 304 may be plasma-processed or an adhesive material may be coated on the PET film 304 such that a surface of the PET 304, which is attached to the graphene 302, may have adhesive properties. In addition, the PET film 304 itself may include a material having adhesive properties.

According to the present embodiment, the PET film 304 is used as a transfer target film on which graphene is transferred. However, the present invention is not limited thereto.

Then, like in the above-described embodiment, a dry etching process (S430), a wet etching process (S440), and a washing and drying process (S150) are performed on the catalyst metal film 301.

Referring to FIG. 9, the catalyst metal film 301 on which the PET film 304 and the graphene 302 are formed is moved to a moving roller (not shown) and is moved to the dry etching space 230, the wet etching space 240, and the washing and drying space 250 by using a roll-to-roll method.

For example, in the dry etching process (S430), the surface of the catalyst metal film 301, on which the graphene 302 is not formed, may be plasma-etched or polished prior to a wet etching process that will be described, thereby reducing a total period of time for an etching process. In the washing and drying space 250, an etching solution that remains on the PET film 304 including the graphene 302 is removed.

Referring to FIG. 13, in the dry etching process (S430) and the wet etching process (S440), the catalyst metal film 301 is removed from the graphene 302.

According to the present embodiment, the PET film 304 is used as a transfer target film on which graphene is transferred. However, the present invention is not limited thereto. A transfer target film on which graphene is transferred may include at least one of polyimide (PI), polydimethylsiloxane (PDMS), plastic, synthetic rubber, and natural rubber, in addition to the PET film 304.

Then, like in the above-described embodiment, a graphene doping process (S460) and a dry process (S470) are performed. Referring to FIG. 9, the PET film 304 including the graphene 302 is moved to a moving roller (not shown) and is moved to the doping space 270 and the dry space 280 by using a roll-to-roll method. In this case, the dry process S470 may be performed by using an air blowing method, or a natural drying method, or alternatively, may be performed by heating the PET film 304 at a temperature of about 50° C.

The PET film including graphene on which the dry process S470 is completely performed may be moved to the moving roller 18 by using a roll-to-roll method and then an analysis process (not shown) may be further performed. A process for transferring graphene on a thermal peel film may be omitted, thereby reducing a total period of time for manufacturing a graphene film and preventing graphene from being damaged while the thermal peel film is attached to or separated from graphene. In addition, dry etching is performed prior to wet etching of a catalyst metal film, thereby reducing a total period of time for an etching process.

According to a method and apparatus for manufacturing a graphene film, a manufacturing method including a process of synthesizing graphene, an etching process, and a transfer process is performed by using a roll-to-roll method, thereby mass-producing a graphene film. In addition, dry etching is performed on a catalyst metal film prior to wet etching, thereby reducing a total period of time for an etching process.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A method of manufacturing a graphene film, the method comprising:
forming graphene on a surface of a catalyst metal film;
forming a first film on a surface of the graphene, on which the catalyst metal film is not formed;
removing the catalyst metal film; and
performing a doping process on the graphene,
wherein the forming of the graphene, the forming of the first film, the removing, and the performing are performed in one direction by using a roll-to-roll method.

2. The method of claim 1, further comprising: prior to the forming of the graphene, preprocessing the catalyst metal film,
wherein the catalyst metal film is moved to the forming of the graphene by using a roll-to-roll method.

3. The method of claim 1, wherein the catalyst metal film comprises at least one selected from the group consisting of nickel (Ni), cobalt (Co), iron (Fe), platinum (Pt), gold (Au), aluminum (Al), chromium (Cr), copper (Cu), magnesium (Mg), manganese (Mn), roseum (Rh), silicon (Si), tantalum (Ta), titanium (Ti), tungsten (W), uranium (U), vanadium (V), and zirconium (Zr), and a combination thereof.

4. The method of claim 1, wherein the first film comprises at least one of polyethylene terephthalate (PET), polyimide (PI), polydimethylsiloxane (PDMS), plastic, synthetic rubber, and natural rubber.

5. The method of claim 4, further comprising forming an adhesive material between the first film and the graphene.

6. The method of claim 1, further comprising: after the removing is performed, removing the first film and forming a second film on a surface of the graphene, on which the first film is not formed.

7. The method of claim 6, wherein the first film is a thermal peel film, and wherein the second film comprises at least one of polyethylene terephthalate (PET), polyimide (PI), polydimethylsiloxane (PDMS), plastic, synthetic rubber, and natural rubber.

8. The method of claim 6, wherein the removing of the first film and the forming of the second film are performed in one direction by using a roll-to-roll method.

9. The method of claim 1, wherein the removing is performed by using an etching process.

10. The method of claim 9, wherein the etching process is a wet etching process using at least one of an acid solution, a hydrogen fluoride (HF) solution, a buffered oxide etch (BOE) solution, a ferric chloride (FeCl3) solution, and a ferric nitrate (Fe(No3)3) solution.

11. The method of claim 10, further comprising: prior to the wet etching process, dry-etching the catalyst metal film.

12. The method of claim 1, further comprising: between the removing and the performing of the doping process, washing and drying the graphene,
wherein the washing and drying are performed by using a roll-to-roll method.

13. The method of claim 1, further comprising: after the performing of the doping process, drying the graphene on which the doping process is performed by using one dry method selected from an air blowing method, a natural drying method, and a heating method at a temperature of about 50° C., wherein the selected method is performed by using a roll-to-roll method.

14. An apparatus for manufacturing a graphene film, the apparatus comprising:
a graphene forming unit for forming graphene on a surface of a catalyst metal film;
a first film forming unit for forming a first film on a surface of the graphene, on which the catalyst metal film is not formed;
a catalyst metal film removing unit for removing the catalyst metal film; and
a graphene doping unit for performing a doping process on the graphene,
wherein the graphene forming unit, the first film forming unit, the catalyst metal film removing unit, and the graphene doping unit are connected by using a roll-to-roll method.

15. The apparatus of claim 14, further comprising a preprocessor for pre-processing the catalyst metal film before graphene is formed on a surface of the catalyst metal film,
wherein the preprocessor and the graphene forming unit are connected by using a roll-to-roll method.

16. The apparatus of claim 14, further comprising a graphene drying unit for drying graphene on which the doping process is performed,
wherein the graphing doping unit and the graphene drying unit are connected by using a roil-to-roll method.

17. A graphene film manufacturing the method of any one of claims 14 through 16.
